(19) United States
(12) Patent Application Publication
(10) Pub. No.: US 2003/0120796 A1
(43) Pub. Date: Jun. 26, 2003

(54) Method for controlling congestion in connection section between ATM network and NON-ATM network

(75) Inventor: Woo Geun Shin, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/284,201

(22) Filed: Oct. 31, 2002

(30) Foreign Application Priority Data
Dec. 26, 2001 (KR) 84719/2001

(51) Int. Cl. G06F 15/16

(52) U.S. Cl. 709/235

(57) ABSTRACT

Disclosed is a system and a method for controlling a congestion in a connection section between an ATM network and a NON-ATM network that promptly provides information regarding congestion that has occurred in the connection section to the TCP source. If congestion occurs in the connection section receiving the IP packet from the TCP source, the congestion information is marked in the response packet received from the TCP destination and provided to the TCP source so that the operation to avoid the congestion is promptly performed. The congestion information is therefore more current, the congestion can be prevented from being aggravated in the connection section due to the propagation delay and the processing delay.

### BACKGROUND OF THE INVENTION

1. Field of the Invention

The present invention relates to a method for controlling network congestion, and more particularly to a method for controlling congestion in the connection section between an Asynchronous Transfer Mode (ATM) network and a NON-ATM network.

2. Background of the Related Art

Asynchronous Transfer Mode (ATM) relates to a data transfer method performed in an asynchronous manner. ATM is often used to provide multimedia service integrating voice, data, and images through a single circuit in real-time and in two-way communications.

Generally, ATM uses a virtual channel circuit-switching mode and performs communication by continuously converting packets of data to 53-byte cells.

An ATM network typically includes a number of ATM switches and it is difficult for the ATM network to exist by itself Thus, it is beneficial for the ATM network and the NON-ATM network to communicate using the ATM network. A Local Area Network (LAN) or a TCP/IP Network can be included in the NON-ATM network.

Since communication environments of the ATM network and the NON-ATM are different from each other (i.e., different protocols and data structures), a connection node (for instance, a router) to connect the ATM network and the NON-ATM network is required. The connection node enables communication between the ATM network and the NON-ATM network.

In the related art and the preferred embodiment of the present invention described hereinafter, it is noted that even if data is sent from a TCP source and received at a TCP destination for convenience, each of the TCP source and the TCP destination can both send and receive data. That is, a TCP source can also receive data as a TCP destination, and when sending data, a TCP destination is a TCP source.

Additionally, it should be understood that congestion could occur at any connection section. For purposes of this discussion, however, congestion at only a first connection section is described. Thus, if data is transferred from the TCP destination, congestion can occur at the corresponding connection section (connection section 14 in FIG. 1).

FIG. 1 illustrates a related art connection relation of the ATM network and the NON-ATM network. As illustrated in FIG. 1, the connection sections 12, 14 exist between the ATM network 13 and the NON-ATM networks 11, 15. Data is transmitted as packet units on the NON-ATM networks 11, 15, and is transmitted as cell-units on the ATM network 13. The packet data is converted to cell data and the cell data is converted to packet data in the connection sections 12, 14.

FIG. 2 illustrates additional detail of the connection sections 12, 14. As illustrated in FIG. 2, it is preferable that each connection section 12, 14 is a connection node, such as a router. The connection node 12 includes a buffer 16, in which IP packets input from the TCP source are temporarily stored. Further, the connection node 12 converts the IP packet stored in the buffer to the 53-byte ATM cell, and transmits the cell to the ATM network 13, depending on the degree of congestion in the ATM network.

The connection section 12, 14 between the ATM network 13 and the NON-ATM network 11, 15 is a section where the traffic input to the ATM network is limited, depending on to the value of the Explicit Cell Rate (ER), which is provided from the ATM network. The ER value is the traffic transmission rate included in the Backward Resource Management (BRM) cell, and indicates the amount of traffic which can be transmitted to the ATM network.

The ATM network 13 provides various traffic management services, such as Constant Bit Rate (CBR), Unspecified Bit Rate (UBR), Variable Bit Rate (VBR), and Available Bit Rate (ABR). Further, in the ATM network 13, the network congestion is controlled by using a congestion control algorithm such as Usage Parameter Control (UPC).

In the first connection section 12, data is transmitted to the ATM network 13 by using the ER value provided through the BRM cell by the ABR traffic management of the ATM network.

Since the ER value is not transmitted to the TCP source, however, the TCP source may optionally transmit the IP packet. Consequently, the number of transmitted IP packets may temporarily increase above the ATM capacity, since the ER value is not transmitted to the TCP source. Thus, congestion occurs in the first connection section 12 if the data input to the ATM network is larger than the ER value.

Generally, in the NON-ATM network, the congestion is controlled by the End-to-End flow control. The congestion control mode in the NON-ATM network is divided into the Random Early Detection (RED) mode and the Explicit Congestion Notification (ECN) mode, which can be used in the connection sections in FIG. 1.

As illustrated in FIG. 3, congestion control is performed by discarding (RED mode) or marking (ECN mode) a corresponding packet when the calculated average amount of data is within a minimum critical value and a maximum critical value. The minimum critical value and maximum critical value are set in the buffer of the connection section 12 (FIG. 2) and the average amount of data is calculated whenever the IP packet is input into the buffer.

A related art method for controlling congestion in a connection section between an ATM network and a NON-ATM network art will be described with reference to FIGS. 4 to 7. FIG. 4 illustrates a report path when congestion occurs in the ATM network and the NON-ATM network in the related art. FIG. 5 is a sequence diagram illustrating a method for controlling congestion in the connection section between the ATM network and the NON-ATM network in the related art.

As illustrated in FIG. 4, according to the related art method for controlling congestion between the ATM network and the NON-ATM network, when congestion occurs in the connection section 12 between the ATM network 13 and the NON-ATM network 11, the congestion alarm is passed from the connection section 12, through the ATM network 13, to the TCP destination, and is then provided back to the TCP source.

Thus, as shown in FIG. 5, according to the related art method for controlling congestion in the connection section, if an IP packet is received from the TCP source (S 51), the average amount of the data stored in the buffer of the connection section 12 is calculated (S 53). The average amount of data is calculated using a weight, which is set according to the status of the network, the previous average amount of data, and the size of the received IP packet.

After determining whether or not the calculated average amount of data in the connection section 12 is between predetermined minimum and maximum critical values (S 55), if the calculated average amount of data has existed, the congestion information is marked Congestion Experienced (CE) at an IP header of the received IP Packet according to probability (FIG. 6) (S 57). The probability is determined using the amount of current data, which is already publicly known and therefore an explanation thereof is omitted here.

As illustrated in FIG. 6, the IP header includes a bit structure, including a Precedence of 3 bits, D of 1 bit to indicate delay or normal, T of 1 bit to indicate whether or not Throughout is normal, R of 1 bit to indicate whether or not Reliability is normal, and Reserved space of 2 bits. Whether or not the ECN is applied is marked (ECT: ECN-Capable-Transport) on 1 bit of the Reserved space, and whether or not congestion has occurred is marked (CE) on the other 1 bit. Standard Documentation RFC791 and RFC2481 include a more detailed explanation of this.

Referring back to FIG. 5, if the calculated average amount of data is not between the minimum and maximum critical values, the connection section 12 discards or passes the received IP packet (S 56). That is, if the calculated average amount of data is less than the minimum critical value, the connection section 12 transmits the IP packet to the ATM network 13. If, however, the calculated average amount of data is more than the maximum critical value, the IP packet is discarded.

In the connection section 12, the IP packet is transmitted to the TCP destination through the ATM network 13 (S 59).

If it is determined from the IP header of the IP packet in the TCP destination that the CE is marked, a response TCP packet is generated, and the ECN Echo Flag is marked on the TCP header of the response TCP packet (FIG. 7) (S 61). FIG. 7 illustrates a bit structure of the TCP header of the response TCP packet. As illustrated in FIG. 7, according to Standard Documentation RFC3168 regulating the portion used in the ECN of the Reserved field, the TCP header includes a Congestion Window Reduced (CWR) of 1 bit to indicate whether or not the window is reduced by the congestion in the Reserved field, and the ECN Capability Flag (ECF) of 1 bit to indicate congestion information, the ECN Echo Flag being marked in the ECE.

In the TCP destination, the response TCP packet is provided to the connection section 12 through the ATM network 13 (S 63).

In the connection section 12, after the response TCP packet is converted to the response IP packet (S 65), the response IP packet is provided to the TCP source (S 67).

In the TCP source, an operation to avoid the congestion is performed by identifying the ECE on the TCP header of the response IP packet to determine whether the congestion information is recorded (S 69).

The related art method for controlling a congestion in a connection section between an ATM network and a NON-ATM networks has various problems. For example, the information of congestion occurring in the connection section is provided to the TCP source by passing the TCP destination through the ATM network. As a consequence, the related art method requires a considerable time due to the propagation delay and the processing delay, resulting from passing through the ATM network and the TCP destination until the congestion information in the connection section is provided to the TPC source. Furthermore, during the corresponding delay time, the congestion of the connection section continues and it thus is impossible to promptly cope with the congestion. In addition, as the delay time is increased, the number of the IP packet being discarded or marked in the corresponding connection section also increases. As the number of re-transmissions of the IP packets being discarded or the number of the IP packets being marked increases accordingly, a greater number of the TCP sources perform the operation of avoiding the congestion, thereby lowering the whole efficiency of the network.

Additionally, as discussed above, the congestion in the connection section between the ATM network and the NON-ATM network occurs because of the change of the data amount being transmitted to the ATM network. Then, the amount of data to be transmitted to the ATM network is sharply increased or decreased according to the change of the corresponding data amount. When the data amount to be transmitted to the ATM network is remarkably reduced, the congestion in the connection section between the ATM network and the NON-ATM network is worse during a short time, and many IP packets are discarded or marked. In this case, if the method for controlling congestion according to the related art is applied, the operation to avoid the congestion is delayed as long as the propagation delay and the processing delay until the operation to avoid the congestion is performed in the TCP source. Consequently, it is impossible to promptly cope with congestion occurring in the connection section.

In addition, as it is impossible to promptly cope with the congestion, a number of IP packets are marked with the congestion information or discarded. Because many of the TCP sources perform the operation to avoid the congestion, the bandwidth capable for use in the ATM network is not sufficiently used.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a method for controlling congestion in a connection section between an ATM network and a NON-ATM network, which can more efficiently resolve congestion occurring in the connection section.

It is another object of the present invention to provide a method for controlling congestion of a connection section between an ATM network and a NON-ATM network, which can indicate whether or not congestion occurs from the connection section to the TCP source without passing through the TCP destination.

It is another object of the present invention to provide a system and method for controlling congestion in a connection section between an ATM network and a NON-ATM network that is configured to transfer whether or not congestion has occurred to the TCP source by identifying just at the connection section without passing through a TCP destination.

To achieve at least the above objects, in whole or in parts, there is provided a method for controlling a congestion in a connection section between an ATM network and a NON-ATM network, which includes marking a congestion information in a response packet to an IP packet provided from a TCP destination before the congestion occurs, if the congestion occurs when the IP packet is received from the TCP source; and providing the congestion information to the TCP source.

The congestion information is preferably marked in the ECN Echo Flag of a response packet. If the average amount of data as calculated in response to the IP packet received from the TCP source is between a minimum critical value and a maximum critical value, the received IP packet is marked or discarded according to the probability calculated with the average amount of data as a variable.

To achieve at least the above objects, in whole or in parts, there is further provided a method for controlling a congestion in a connection section between an ATM network and a NON-ATM network, including identifying whether the average amount of data is between a minimum critical value and a maximum critical value when an IP packet is received from an TCP source; if the average amount of data is between the minimum and the maximum critical values, identifying whether a response packet to a previous IP packet transmitted from the TCP source has arrived from a TCP destination; and if the response packet to the previous IP packet has arrived, marking the congestion information in the response packet and providing to the TCP source.

To achieve at least the above objects, in whole or in parts, there is further provided a method for controlling a congestion in a connection section between an ATM network and a NON-ATM network, including if an average amount of data is between a minimum critical value and a maximum critical value, determining whether the IP packet is discarded or marked according to the probability being calculated with the average amount of data as a variable, when the IP packet is received from the TCP source; if the IP packet is determined as being marked, identifying whether a response packet to a previous IP packet transmitted from the TCP source has arrived from a TCP destination; and if the response packet to the previous IP packet has arrived, marking the congestion information in the response packet and providing the congestion information to the TCP source.

To achieve at least the above objects, in whole or in parts, there is further provided a method for controlling congestion in a communication network in which a NON-ATM network is combined with an ATM network through a medium of a connection section, including transmitting an IP packet in a TCP source to the connection section through the NON-ATM network; determining whether congestion has occurred by calculating the average amount of data of the IP packets stored in a buffer in the connection section; if the connection section is determined to have congestion, identifying whether a response packet to a previous IP packet transmitted from the TCP source has arrived from a TCP destination; if the response packet to the previous IP packet has arrived in the connection section, marking the congestion information in a response packet and providing congestion information to the TCP source through the NON-ATM network; and performing an operation to avoid the congestion by recognizing the congestion from the response packet in the TCP source. If the average amount of data is between a minimum and a maximum critical values, the connection section is determined as a congested section.

To achieve at least the above objects, in whole or in parts, there is further provided a method for controlling congestion in a connection section between an ATM network and a NON-ATM network, including synchronously marking congestion information in an IP packet and in a response packet to a previous IP packet provided from a TCP destination before the congestion occurs, if the congestion occurs when the IP packet is received from the TCP source.

To achieve at least the above objects, in whole or in parts, there is further provided a method for controlling congestion in a connection section between an ATM network and a NON-ATM network, including identifying whether the average amount of data is between a minimum critical value and a maximum critical value when the IP packet is received from a TCP source; if the average amount of data is between the minimum and the maximum critical values, marking a congestion information in the IP packet and a response packet; and providing the response packet being marked with the congestion information to the TCP source.

To achieve at least the above objects, in whole or in parts, there is further provided a method for controlling congestion in a connection section between an ATM network and a NON-ATM network, including identifying whether an average amount of data as calculated is between a minimum critical value and a maximum critical value when an IP packet is received from the TCP source; if the average amount of data is between the minimum and the maximum critical values, marking a congestion information in a CE of the IP packet and transmitting it to a TCP destination; identifying whether the congestion information is marked in the response packet received from the TCP destination; and if the congestion information is not marked in the response packet, marking the congestion information in an ECN Echo Flag of the response packet.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a combination relation of a related art ATM network and NON-ATM network;

FIG. 2 illustrates a connection node of the general connection section of FIG. 1;

FIG. 3 illustrates a related art ECN algorithm;

FIG. 4 illustrates a related art path to report congestion when it occurs in the ATM network and the NON-ATM network;

FIG. 5 is a sequence diagram illustrating a related art method for controlling congestion in the connection section between an ATM network and a NON-ATM network;

FIG. 6 illustrates an IP header of an IP packet being generated at a TCP source of the related art;

FIG. 7 illustrates a TCP header of a response packet being generated in a TCP destination of the related art;

FIG. 8 illustrates a path to report congestion when it occurs in an ATM network and a NON-ATM network according to a preferred embodiment of the present invention;

FIG. 9 is a sequence diagram illustrating a method for controlling congestion in a connection section between an ATM network and a NON-ATM network according to a preferred embodiment of the present invention; and

FIG. 10 is a sequence diagram illustrating a method for controlling congestion in a connection section between an ATM network and a NON-ATM network according to another preferred embodiment of the present invention.

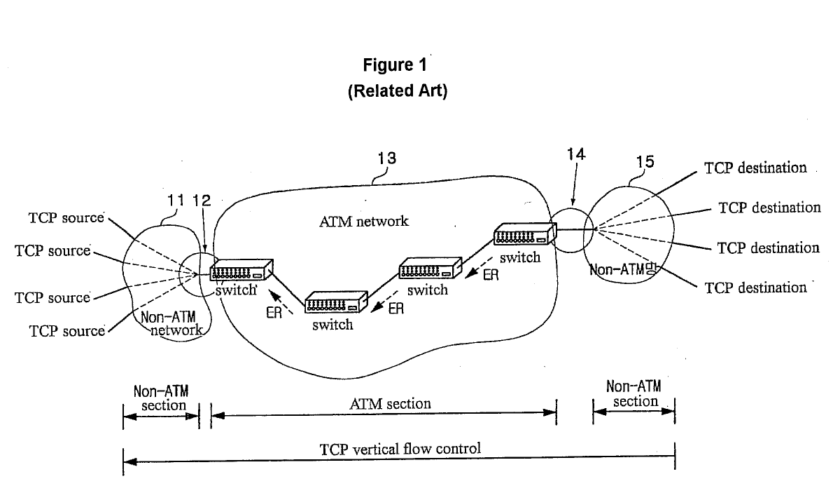

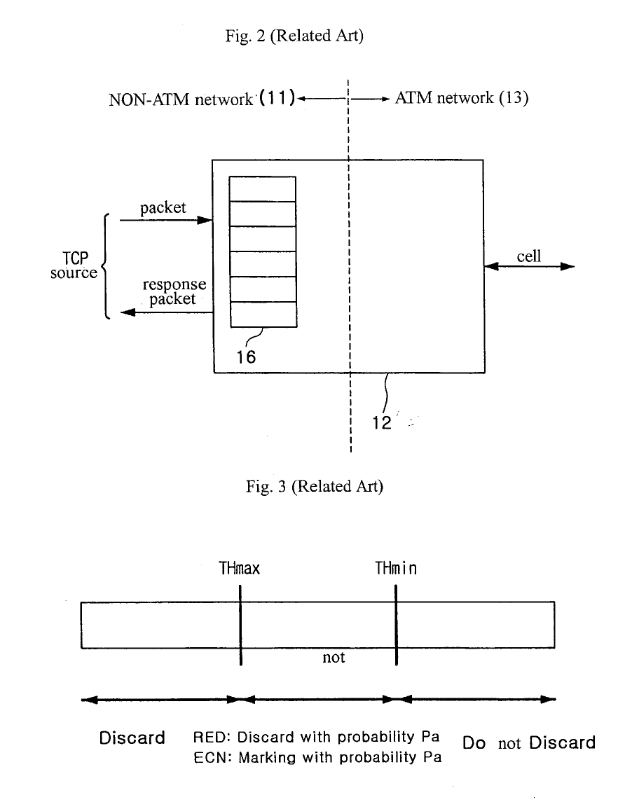

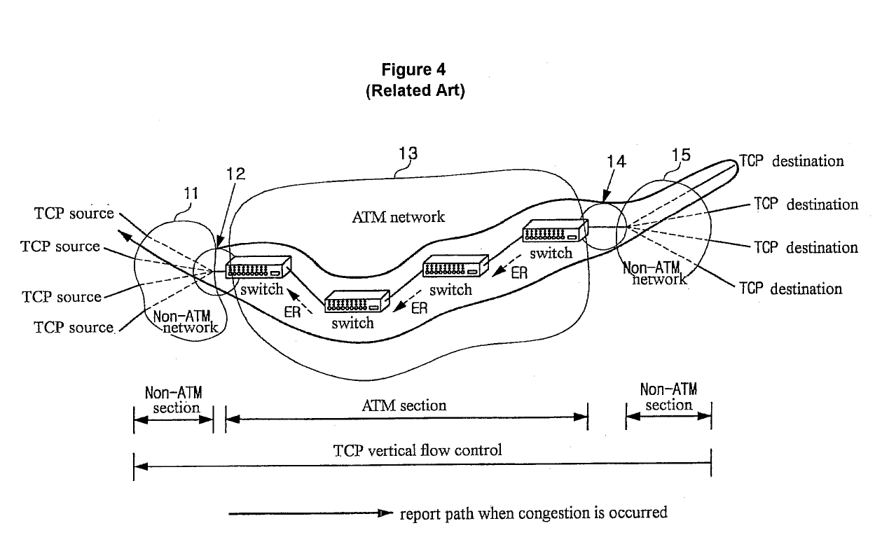

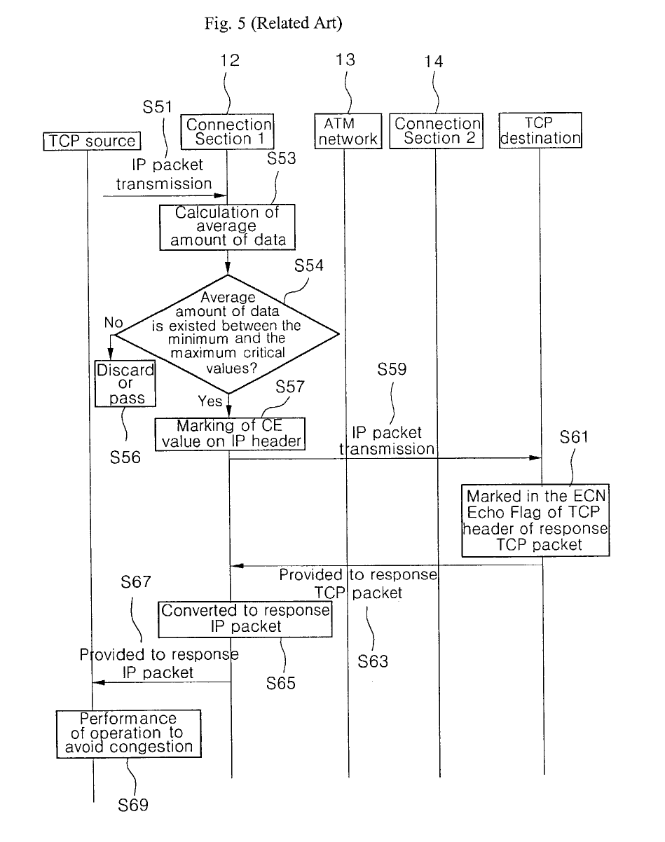

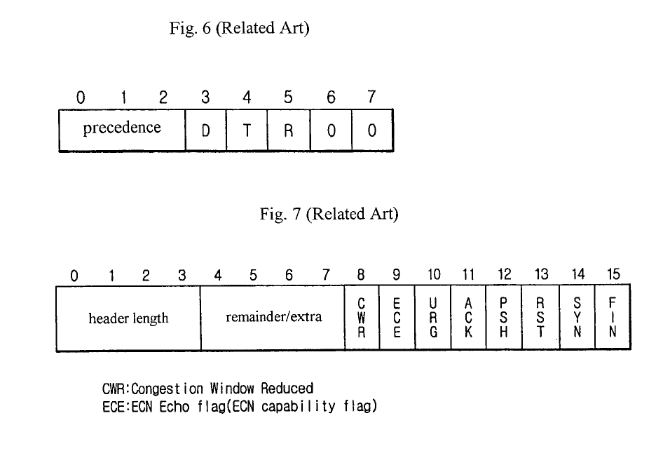

### DETAILED DESCRIPTION OF PREFERRED EMBODIMENTS

The following detailed description will present a preferred embodiment of the invention in reference to the accompanying drawings.

As described above, according to the related art method for controlling a congestion in a connection section between an ATM network and a NON-ATM network, the average amount of data is calculated whenever an IP packet is received from the TCP sources. A determination of whether or not congestion has occurred is made by comparing the predetermined minimum critical value and maximum critical value to the average. If the connection section is determined to be as congested, the congestion information is marked in a CE (Congestion Experienced) part of the IP header of the IP packet as received, and is transmitted to a next TCP destination. In the TCP destination, the congestion information is marked in a response packet being generated in response to the IP packet. That is, the information is marked in an ECN Echo Flag of the TCP header of the TCP packet, and the congestion information is provided to the TCP source through the ATM network and the connection section. An operation to avoid the congestion is then performed. The response packet indicates the packet being generated in response to the IP packet sent from the TCP source to the TCP destination through the connection section.

The method for controlling congestion of the related art requires much time to inform the TCP source of the congestion by passing through the ATM network and returning to the TCP destination and then again passing through the ATM network. Furthermore, it additional time is taken for the TCP source to perform the operation to avoid the congestion. Therefore, since the data from the TCP source is continuously transmitted to the connection section, congestion in the connection section is increased.

According to the preferred embodiment of the present invention, on the other hand, if the congestion occurs in the connection section between the ATM network and the NON-ATM network, the trouble of passing through the TCP destination to inform the TCP source of the congestion is prevented by not marking the congestion information in the IP packet, but by marking it in the response packet generating in response to the previous IP packet in the TCP destination. The previous IP packet is the packet generated in response to the IP packet being transmitted from the TCP source to the TCP destination through the connection section before the congestion occurs.

In addition, since the congestion information is instantly provided to the TCP source, the operation to avoid the congestion is performed at once, thereby reducing the amount of data to be transmitted to the connection section and immediately coping with the congestion in the connection section. The capability of the communication network is consequently improved.

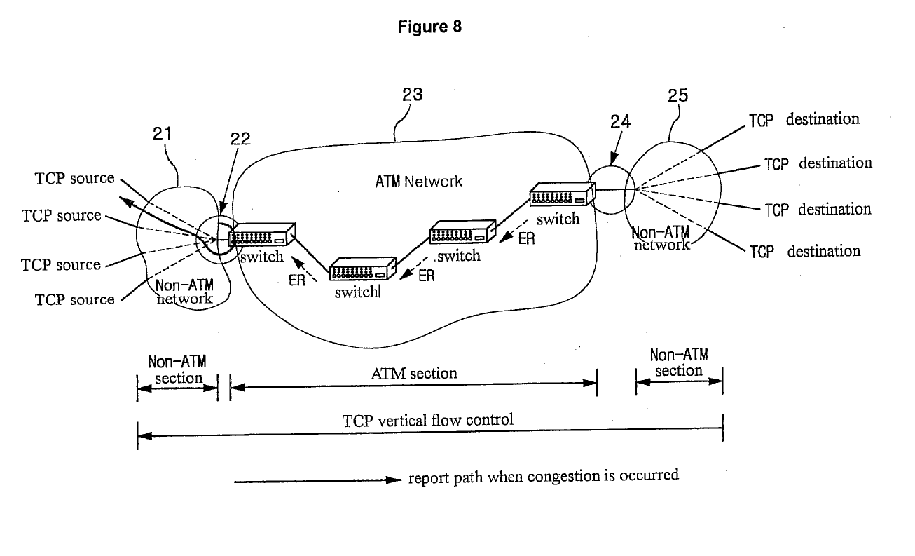

FIG. 8 illustrates a path to report congestion that has occurred in the connection section 22 between the ATM network 23 and the NON-ATM network 21, according to the preferred embodiment. It should be understood that any connection section could be used. However, for purposes of this example, connection section 21 is discussed. As shown in FIG. 8, the IP packet is received from the TCP source in the connection section 22, 24 between the ATM network 23 and the NON-ATM network 21, 25. The average amount of data should be between the minimum critical value and the maximum critical value. When congestion information is marked by the probability determined by the average amount of data, instead of marking the congestion information in the IP packet and transmitting the congestion information to the TCP destination, it is determined whether a response packet to a previous IP packet has arrived from the TCP destination. If so, the congestion information is marked in that response packet and is then provided to the TCP source. The operation of avoiding the congestion is thus quickly performed. Here, the response packet is a packet generated in response to a previous IP packet transmitted to the TCP destination through the connection section from the TCP source before the congestion occurred.

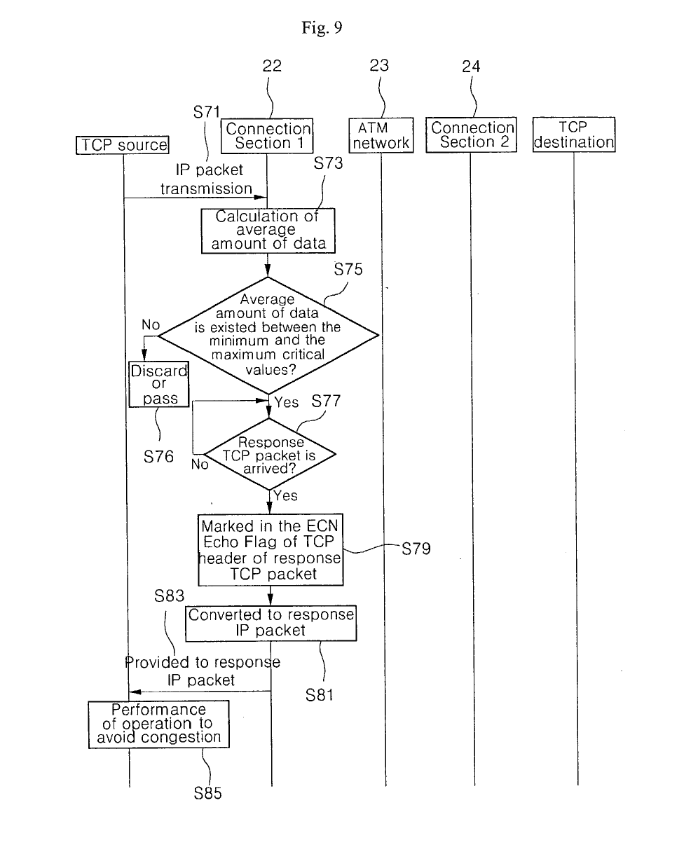

FIG. 9 illustrates a method for controlling congestion in a connection section between an ATM network and a NON-ATM network according to a preferred embodiment of the present invention. Referring to FIG. 9, the TCP source 21 divides the required data into IP packet units and transmits the data (S 71). Typically, an IP packet is divided into the IP header and the data area. The IP header preferably includes the TCP source address, the TCP destination address, and the control information. The data area preferably includes voice, data, and image information. The transmitted IP packet is next converted into the 53-byte ATM cell in the connection section 22 and is transmitted to the ATM network 23. At this time, in the connection section 22, the average amount of data is calculated based on the IP packets stored in the internal buffer whenever an IP packet is received from the TCP source (S 73). Usually, the average amount of data is calculated by the variables such as the previous average amount of data, weight, and current average size of a cue. Such information is already known in the art and thus any additional explanation thereof is omitted.

The connection section 22 preferably comprises a router including a buffer. The buffer stored IP packets received from the TCP source. Usually, data to be transmitted to the ATM network 23 is limited by the ER value being provided from the ATM network. The ER value is preferably variably converted according to the status of the ATM network. Based on the ER value, which takes the status of the ATM network into consideration, the minimum critical value and the maximum critical value are set in the buffer.

In the connection section 22, it is next determined whether the average amount of data is between the thusly set minimum and maximum critical values (S 75).

If the average amount of data regarding the IP packets stored in the buffer is less than the minimum critical value, the data is transmitted to the ATM network 23 as is. In addition, if the average amount of data regarding the IP packets is greater than the maximum critical value, all data is discarded, since the data larger than the ER value provided from the TCP destination is stored in the buffer (S 76).

If, however, the average amount of data is between the minimum and the maximum critical values, congestion is determined to have occurred. The congestion information is either discarded or marked by the probability calculated using the average amount of data. Here, marking means that congestion information is included in the IP packet.

If the IP packet is determined to have been marked in the connection section 22, the connection section 22 identifies whether a response TCP packet for a previous IP packet has arrived from the TCP destination (S 77). The response TCP packet is preferably the TCP packet generated in response to the previous IP packet transmitted from the TCP source before the congestion occurred, and indicates that the safe transmission to the TCP destination through the connection section 22. In general, when the IP packet is transmitted from the TCP source to the TCP destination, the response TCP packet is generated and provided to the TCP source.

As a result of identification, if such a response TCP packet has been received from the TCP destination, the connection section 22 identifies whether the address of the TCP source included in the TCP header of the response TCP packet is identical to the address of the TCP source included in the IP packet. If the address of the TCP source included in the TCP header is identical to the address of the TCP source included in the IP packet, the connection section 22 marks the congestion information in the ECN Echo Flag of the TCP header of the response TCP packet (S 79).

The response TCP packet, having been marked with the congestion information, is converted to the response IP packet and is then provided to the TCP source (S 81, S 83).

The TCP source 21 receives the thusly marked packet and recognizes that congestion has occurred based on the TCP header of the response IP packet. The TCP source 21 then performs the operation to avoid the congestion (S 85).

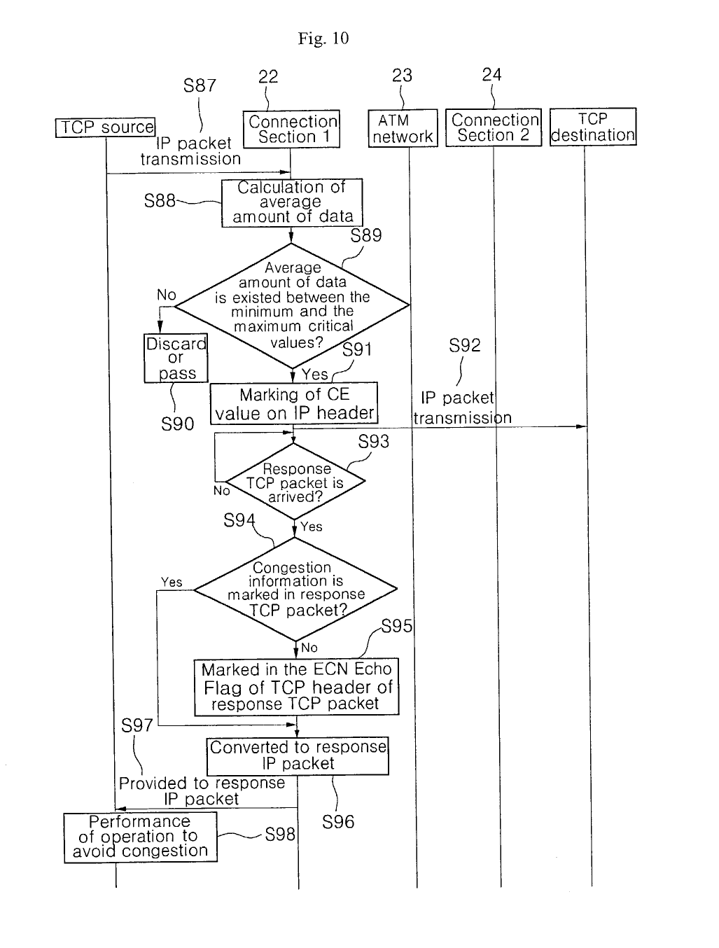

FIG. 10 illustrates a method for controlling network congestion according to a second embodiment of the present invention. According to the second embodiment, when the congestion occurs in the connection section, the congestion information is marked in the IP packet and is simultaneously transmitted to the TCP destination. The congestion information is also marked in the response TCP packet, which is generated in response to an IP packet being transmitted to the TCP destination before the congestion occurred, and is provided to the TCP source.

In FIG. 10, Steps 87 to 89 are identical with those of FIG. 9. That is, the IP packet is transmitted from the TCP source to the connection section 22 (S 87) and the average amount of data is calculated in the connection section 22 (S 88). It is then determined whether the average amount of data is between the minimum and the maximum critical values (S 89).

If the average amount of data is not between the minimum and the maximum critical values, the corresponding IP packet is either discarded or passed through the connection section 22 (S 90).

If, however, the average amount of data is between the minimum and the maximum critical values, congestion is determined to have occurred. The congestion information is thus preferably marked in the CE (Congestion Experienced) of the IP header of the IP packet (S 91).

In the connection section 22, the IP packet is preferably transmitted to the TCP destination through the ATM network 23 (S 92).

Simultaneously, the connection section 22 preferably identifies whether a response TCP packet has arrived from the TCP destination (S 93). The response TCP packet is a the TCP packet generated in response to a previous IP packet safely transmitted from the TCP source to the TCP destination through the connection section 22.

If a response TCP packet is identified as having been received from the TCP destination, the connection section 22 determines whether the congestion information is marked in the response TCP packet (S 94). If the packet is already marked based on congestion as described in Step 92, the IP packet, with the marked CE value, is transmitted to the TCP destination. In the TCP destination if the CE value is marked in the IP packet, the congestion information is marked in the ECN Echo Flag of the response TCP packet and is sent to the connection section 22.

Further, an IP packet that was transmitted before the congestion occurred could be in the TCP destination. Therefore, in the TCP destination, it is possible to transmit to the connection section 22 the response TCP packet to the IP packet that was transmitted before the congestion occurred. Therefore, at Step S 94, the response TCP packet marked with the congestion information is distinguished from the response TCP packet not marked with the congestion information.

If the congestion information is not marked in the response TCP packet received by the connection section 22, the congestion information is marked in the ECN Echo Flag of the response TCP packet (S 95). The thusly marked response packet is then converted to the response IP packet, and is provided to the TCP source (S 96, S 97).

If, however, the congestion information is already marked in the response TCP packet, the response TCP packet is simply converted to the response IP packet (S 96) and provided to the TCP source (S 97).

The TCP source recognizes that congestion has occurred based on the TCP header of the response IP packet and performs an operation to avoid the congestion (S 98).

Likewise, when congestion has occurred in the connection section 22, the congestion information is marked in the IP packet to be transmitted to the TCP destination, and is simultaneously marked in the response TCP packet to the IP packet provided from the TCP destination prior to the congestion. This prevents the IP packet that has been marked with the congestion information from being lost.

The system and method for controlling congestion in a connection section between an ATM network and a NON-ATM network in the preferred embodiment has many advantages. For example, the congestion information is marked in a response packet to a previous packet and is immediately sent to the TCP source. Thus the TCP source is immediately notified of congestion so that the operation to avoid the congestion is performed, thereby shortening the propagation delay and the processing delay in the NON-ATM network. Congestion in the connection section is reduced and the system can promptly cope with the congestion to stabilize the whole network.

Furthermore, because the TCP source is immediately notified of the congestion, it can promptly cope with the congestion. Consequently, a large capacity buffer to store traffic during the long delay time is not necessary. Bandwidth is also efficiently used in the ATM network.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for controlling congestion in a connection section between an ATM network and a NON-ATM network, comprising:
marking a congestion information in a response packet if congestion occurs when a current IP packet is received from a TCP source, the response packet being an IP packet provided from a TCP destination as a response to a previous IP packet sent from the TCP source before the congestion occurred; and
providing the response packet with the congestion information to the TCP source.

2. The method of claim 1, wherein the congestion information is marked in an ECN Echo Flag of the response packet.

3. The method of claim 1, wherein if an average amount of data as calculated in response to the current IP packet received from the TCP source is between a minimum critical value and a maximum critical value, the current IP packet is one of marked and discarded according to a probability calculated with the average amount of data as a variable.

4. A method for controlling congestion in a connection section between an ATM network and a NON-ATM network, comprising:
determining whether an average amount of data is between a minimum critical value and a maximum critical value when a current IP packet is received from a TCP source;
if the average amount of data is between the minimum and the maximum critical values, identifying whether a response packet to a previous IP packet transmitted from the TCP source has arrived from a TCP destination; and
if the response packet to the previous IP packet has arrived, marking congestion information in the response packet and sending the marked response packet to the TCP source.

5. The method of claim 4, wherein if the average amount of data is between the minimum and the maximum critical values, the IP packet is one of discarded and marked according to a probability calculated with the average amount of data as a variable.

6. The method of claim 4, wherein the congestion information is marked in an ECN Echo Flag of the response packet.

7. The method of claim 4, further comprising marking the current IP packet with congestion information.

8. A method for controlling congestion in a connection section between an ATM network and a NON-ATM network, comprising:
determining whether to discard or mark a current IP packet according to a probability being calculated with an average amount of data as a variable, if the average amount of data is between a minimum critical value and a maximum critical value, when the current IP packet is received from a TCP source;
if it is determined to mark the current IP packet, identifying whether a response packet to a previous IP packet transmitted before the current IP packet from the TCP source has arrived from a TCP destination; and
if the response packet to the previous IP packet has arrived, marking congestion information in the response packet and sending the response packet marked with the congestion information to the TCP source.

9. A method for controlling congestion in a communication network in which a NON-ATM network is combined with an ATM network through a medium of a connection section, comprising:
transmitting a current IP packet from a TCP source to a connection section through a NON-ATM network;
determining whether the connection section is congested by calculating an average amount of data of stored IP packets stored in a buffer in the connection section;
if the connection section is determined to be congested, identifying whether a response packet to a previous IP packet transmitted from the TCP source before transmission of the current IP packet has arrived from a TCP destination; and
if the response packet has arrived in the connection section, marking congestion information in the response packet and transmitting the response packet marked with the congestion information to the TCP source through the NON-ATM network.

10. The method of claim 9, further comprising performing an operation to avoid the congestion by recognizing the congestion from the response packet in the TCP source.

11. The method of claim 9, wherein if the average amount of data is between a first value and a second value, the connection section is determined to be congested.

12. The method of claim 9, further comprising marking the current IP packet with congestion information.

13. A method for controlling congestion in a connection section between an ATM network and a NON-ATM network, comprising:
simultaneously marking congestion information in a current IP packet and in a response packet to a previous IP packet provided from a TCP destination before congestion occurred, if the congestion occurs when the current IP packet is received from a TCP source.

14. The method of claim 13, further comprising sending the marked current IP packet to the TCP destination and the marked response packet to the TCP source.

15. The method of claim 13, further comprising determining whether congestion information is marked in the response packet when the response is received from the TCP destination.

16. The method of claim 15, wherein if the congestion information is determined to be already marked in the response packet, the response packet is provided to the TCP source without modification.

17. The method of claim 15, wherein, if the congestion information is not marked in the response packet, the congestion information is marked in an ECN Echo Flag of the response packet.

18. A method for controlling congestion in a connection section between an ATM network and a NON-ATM network, comprising:
identifying whether a calculated average amount of data is between a minimum critical value and a maximum critical value when a current IP packet is received from a TCP source;
if the average amount of data is between the minimum and the maximum critical values, marking congestion information in a CE of the current IP packet and transmitting the current IP packet to a TCP destination;
identifying whether the congestion information is marked in a response packet received from the TCP destination; and if the congestion information is not marked in the response packet, marking the congestion information in an ECN Echo Flag of the response packet.

19. The method of claim 18, further comprising transmitting the marked response packet to the TCP source.

20. The method of claim 18, wherein the TCP destination receives the marked current IP packet and generates a response packet with the ECN Echo Flag marked.

21. The method of claim 18, wherein the response packet being not marked is a packet generated in response to a previous IP packet transmitted to the TCP destination before the congestion occurred.

22. The method of claim 18, wherein the response packet is an IP packet sent from a TCP destination in response to a previous IP packet sent from the TCP source prior to the current IP packet.

23. A communication system, comprising:
a TCP source for sending and receiving IP packets;
an ATM network for sending and receiving ATM cells; and
a connection section for connecting the ATM network with the TCP source and converting ATM cells to IP packets and IP packets to ATM cells, wherein the connection section is configured to mark congestion information in a response IP packet to be transmitted to the TCP source if congestion occurs when a current IP packet is received from the TCP source, the response IP packet being provided from a TCP destination as a response to a previous IP packet sent from the TCP source prior to the current IP packet.

24. A connection section for connecting an ATM network with a non-ATM network, comprising:
a TCP source connection part configured to couple with a TCP source to transmit and receive IP packets; an ATM network connection part configured to couple with a ATM network to transmit and receive ATM packets; and
a buffer configured to store IP packets, wherein the connection section is configured to convert IP packets into ATM cells for transmission to the ATM network, and convert ATM cells into IP packets for transmission to the TCP source, and wherein the connection section is further configured to mark congestion information in a response IP packet to be transmitted to the TCP source if congestion occurs when a current IP packet is received from the TCP source, the response IP packet being provided from a TCP destination as a response to a previous IP packet sent from the TCP source prior to the current IP packet.
